(19) United States
(12) Patent Application Publication
(10) Pub. No.: US 2008/0199189 A1
(43) Pub. Date: Aug. 21, 2008

(54) COLORLESS OPTICAL DEMODULATOR FOR DIFFERENTIAL QUADRATURE PHASE SHIFT KEYING DWDM SYSTEMS

(75) Inventors: Lei XU, PRINCETON, NJ (US); Philip Nan JI, PRINCETON, NJ (US); Jianjun YU, PRINCETON, NJ (US); Milorad CVIJETIC, HERNDON, VA (US); Yutaka YANO, CHIBA (JP); Tsutomu TAJIMA, CHIBA (JP); Shinya NAKAMURA, CHIBA (JP); Ting Wang, PRINCETON, NJ (US)

Correspondence Address: BROSEMER, KOLEFAS & ASSOCIATES, LLC, 1 BETHANY ROAD, BUILDING 4 - SUITE # 58, HAZLET, NJ, 07730, US

(73) Assignee: NEC AMERICA INC., HERNDON, VA (US)

(21) Appl. No.: 11/676,519

(22) Filed: Feb. 20, 2007

(51) Int. Cl. H04J 14/00

(52) U.S. Cl. 398/188

(57) ABSTRACT

A colorless optical DQPSK demodulator and system operating over multiple, equally-spaced DWDM channels with fixed optical delays—capable of demodulating DQPSK within signals within DWDM communications wave bands on ITU grids using delay interferometers having fixed free spectral range at 20 GHz or 25 GHz.

### FIELD OF THE INVENTION

This invention relates generally to the field of telecommunications systems and in particular relates to an optical modulator for use in dense wavelength division multiplexed (DWDM) transmission systems employing differential quadrature phase shift keying (DQPSK) modulation.

### BACKGROUND OF THE INVENTION

With an increased demand for new telecommunications services such as online gaming, and on-demand video services comes an increased need for communications bandwidth. Accordingly, the incentives for carriers to deploy next-generation DWDM transmission systems operating at 40 Gb/s and beyond are great.

Unfortunately however, upgrading existing DWDM networks from 10 Gb/s to 40 Gb/s, presents a number of technical challenges. For example, when compared with 10 Gb/s signals, 40 Gb/s signals generally tolerate only one sixteenth the amount of chromatic dispersion (CD), and one fourth the amount of polarization mode dispersion (PMD), while simultaneously requiring an optical signal-to-noise ratio (OSNR) that is four times greater and exhibiting a signal bandwidth that is four times a broad.

Accordingly, the prior art has provided mechanisms to extend the reach and improve the spectral efficiency of such systems involving new modulation schemes (See, for example, A. Hod\check{z}ic, B. Konrad, and K. Petermann, “Alternative Modulation Formats in N 40 Gb/s WDM Standard Fiber RZ-Transmission Systems”, IEEE Journal of Lightwave Technology, v20, p 598, 2002; H. Bissessur, G. Charlet, C. Simonneau, S. Borne, L. Pierre, C. De Barros, P. Tran, W. Idler, R. Dischler, “3.2 Tb/s (80/spl times/40 Gb/s) C-band transmission over 3/spl times/100 km with 0.8 bit/s/Hz efficiency”, ECOC 2001, p 22; A. H. Gnauck, P. J. Winzer, “Optical phase-shift-keyed transmission”, Journal of Lightwave Technology, v23, pp 115-130, 2005; and Griffin, R. A.; Carter, A. C., “Optical differential quadrature phase-shift key (ODQPSK) for high capacity optical transmission”, OFC 2002, p 367). Among the modulation schemes explored, optical DQPSK has been shown to be particularly advantageous.

As a result of its multi-level modulation, the sample rate for optical DQPSK signals is one-half the data bit rate which results in a higher spectral efficiency and greater tolerance to CD and PMD. In addition, the characteristic equalized signal energy per bit period for DQPSK signals significantly reduces signal degradations due to fiber nonlinearities. Finally, and as compared with intensity modulated signals, optical DQPSK signals may exhibit higher receiver sensitivity as a result of a balanced detection mechanism, which can further reduce the necessary optical transmission power while permitting longer transmission spans.

Despite its attractiveness however, optical DQPSK modulation for 40 Gb/s optical transmission systems is among the most complicated and expensive to implement. More specifically, present-day optical DQPSK transmitters require two sets of DPSK modulators cascaded either in serial or in parallel to separately encode In-phase (I) and Quadrature-phase (Q) components of the DQPSK signals. (See, for example, Yoshikane, N.; Morita, I., “1.14 b/s/Hz spectrally efficient 50/spl times/85.4-Gb/s transmission over 300 km using copolarized RZ-DQPSK signals”, IEEE Journal of Lightwave Technology, v23, p 108, 2005; Griffin, R. A., “Integrated DQPSK transmitters”, OFC 2005, paper OWE3; and Serbay, M.; Wree, C.; Rosenkranz, W., “Comparison of six different RZ-DQPSK transmitter set-ups regarding their tolerance towards fibre impairments in 8×40 Gb/s WDM-systems”, IEEE LEOS workshop on Advanced Modulation Formats, 2004, paper ThB3) Similarly, present-day DQPSK receivers include two sets of DPSK demodulators to separately convert the phase modulation to intensity modulation for the I and Q phase components.

Accordingly, optical devices that improve the performance and/or reduce the cost of optical communications systems and networks thereof would represent a significant advance in the art.

### SUMMARY OF THE INVENTION

In accordance with the present invention, a colorless DQPSK demodulation technique is disclosed which demodulates signals at different wavelengths on ITU grids through the use of fixed passive devices.

In sharp contrast with the prior art devices, DQPSK demodulators constructed according to the present invention do not require active, precise control of the optical delay exhibited for signals at different wavelengths. As a result, demodulators constructed according to the present invention dramatically simplify the operation of systems employing DQPSK demodulators and advantageously reduce overall system cost.

### BRIEF DESCRIPTION OF THE DRAWING

Further features and advantages of the present invention will become apparent to those skilled in the art with reference to the drawing in which:

FIG. 1 is a schematic illustration of an optical DQPSK transmitter exhibiting (A) a parallel structure and (B) a serial structure;

FIG. 2 is a schematic illustration of an optical DQPSK receiver having Mach-Zehnder structures and balanced detectors;

FIG. 3 is series of graphs showing the transmission coefficients for an I phase detector under different at different Δφ_{B} at central frequencies of (FIG. 3(A)) 193.2 THz; (FIG. 3(B)) 193.1 THz; and (FIG. 3(C)) 193.25 THz under fixed optical delay of τ=46.728778 ps.

FIG. 4 is a series of graphs showing the transmission coefficients after balanced detection for lightwave frequencies of 193.2 THz (FIG. 4(A)), 193.1 THz (FIG. 4(B)), and 193.25 THz (FIG. 4(C)).

FIG. 5 is a block diagram of a network showing a balanced detection with fixed delay of a DQPSK signal according to the present invention;

FIG. 6(A) is a series of graphs showing eye diagrams for A1 Constructive port output, A2 Destructive port output, and A3 Balanced detection output for a signal frequency of 193.1;

FIG. 6(B) is a series of graphs showing eye diagrams for B1 Constructive port output, B2 Destructive port output, and B3 Balanced detection output for a signal frequency of 193.1;

FIG. 6(C) is a series of graphs showing eye diagrams for C1 Constructive port output, C2 Destructive port output, and C3 Balanced detection output for a signal frequency of 193.1;

FIG. 7(A) is a series of graphs showing eye diagrams for A1 Constructive port output, A2 Destructive port output, and A3 Balanced detection output for a signal frequency of 193.1;

FIG. 7(B) is a series of graphs showing eye diagrams for B1 Constructive port output, B2 Destructive port output, and B3 Balanced detection output for a signal frequency of 193.1;

FIG. 7(C) is a series of graphs showing eye diagrams for C1 Constructive port output, C2 Destructive port output, and C3 Balanced detection output for a signal frequency of 193.1;

FIG. 8 is a graph of Q factor (dB) vs. Frequency (THz) for a series of OSNR values;

FIG. 9 is a graph of Q factor (dB) vs. Frequency (THz) for a series of OSNR values;

FIG. 10 is a series of graphs of Eye Opening Penalty (dB) vs. Frequency Offset (GHz);

FIG. 11 is a schematic diagram of a reconfigurable optical add/drop multiplexer according to the present invention.

### DETAILED DESCRIPTION

Optical DQPSK Transmitter and Signal Demodulation

By way of further background it is known that each symbol transmitted in a DQPSK transmission system can have four possible phase values namely, 0, π/2, π and 3π/2 which represent data bit values of 00, 10, 11, 01, respectively. Advantageously, with DQPSK transmission, the symbol rate is only one-half of the data bit rate thereby reducing the signal spectral width by a factor two and increasing the systems tolerance to chromatic dispersion and polarization mode dispersion. (See, e.g., A. H. Gnauck, P. J. Winzer, “Optical phase-shift-keyed transmission”, Journal of Lightwave Technology, v23, pp 115-130, 2005; Griffin, R. A.; Carter, A. C., “Optical differential quadrature phase-shift key (ODQPSK) for high capacity optical transmission”, OFC 2002, p 367).

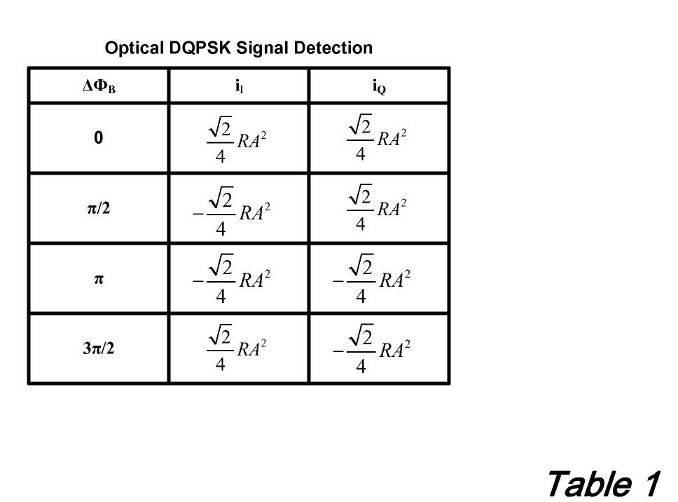

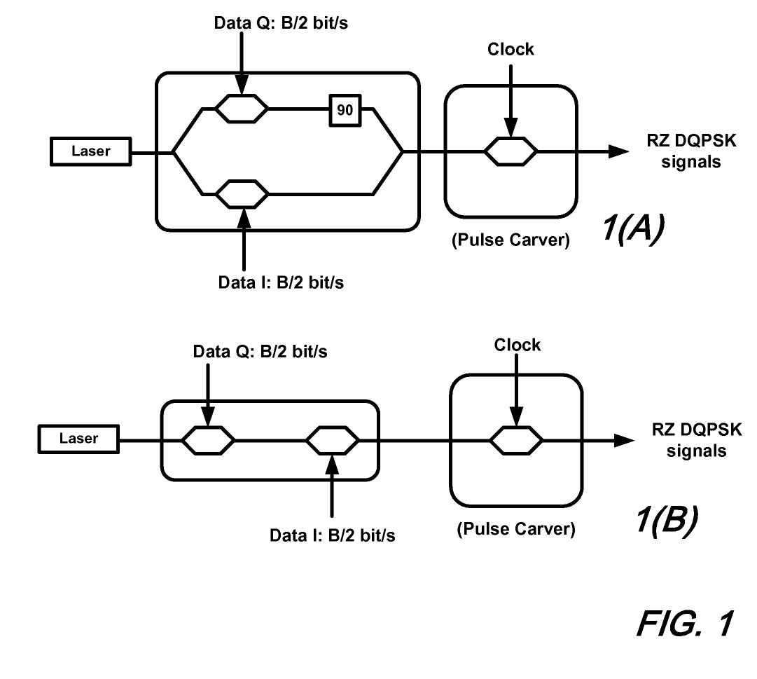

Turning now to FIG. 1, there it shows two transmitter structures that are employed in two representative approaches to generate and transmit optical DQPSK signals: In particular, a parallel transmitter is shown in FIG. 1(A) and a serial transmitter is shown in FIG. 1(B). In both of these approaches, Q phase and I phase components—which are binary signals exhibiting a rate of one-half that of the data bit rate—are extracted from the incoming data signals after differential encoding.

In the parallel approach shown in FIG. 1(A), both the Q-phase and I-phase data signals drive phase modulators to generate 0 or π changes to the input laser light. In one of the branches, 90-degree phase change is introduced into the signal for quadrature phase modulation. In preferred embodiments of such parallel configurations, the two phase modulators and the phase shifter is integrated onto the same chip to ensure phase stability.

In the serial approach to DQPSK modulation shown in FIG. 1(B), two phase modulators are cascaded. One of the phase modulators is driven by the Q phase data to cause phase changes of 0 or π/2 to the laser light carrier signal, and the other phase modulator is driven by the I phase data for phase changes of 0 or π. And while such serial configurations oftentimes introduce greater loss to the optical signal, they nevertheless exhibit similar performance to that exhibited by parallel configurations.

With each of the approaches depicted in FIG. 1(A) and FIG. 1(B), the initial modulator output is an NRZ-DQPSK signal. However, since the phase modulation is not instantaneous, chirp—where phase changes with time—occurs during bit transitions. As is known by those skilled in the art, chirp causes extra spectral broadening of the signal, and can result in more dramatic dispersion during signal transmission in fiber. Consequently, a clock driven intensity modulator is frequently used to “carve” pulses out of the phase-modulated signal, thus eliminating that portion of the signal having chirp. Such a signal is known in the art as RZ DQPSK signal, and it has been shown to be well suited for high-speed, long distance transmissions.

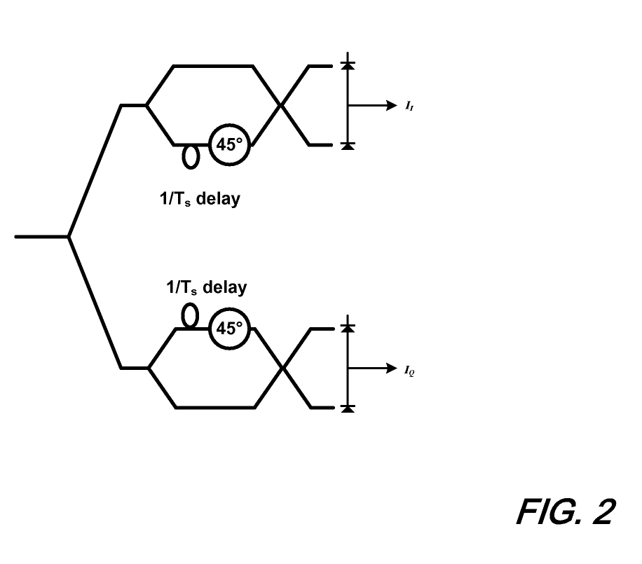

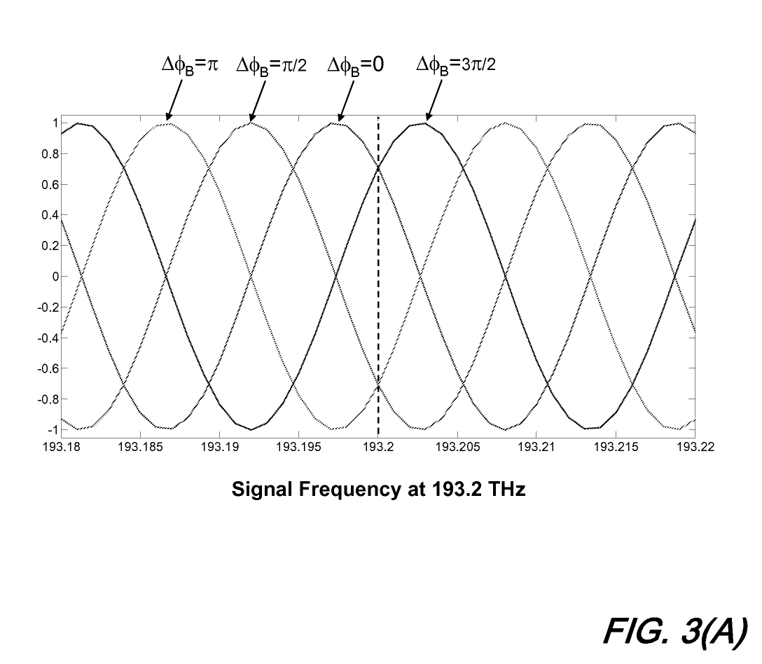

While not specifically shown in FIG. 1, those skilled in the art will readily appreciate that at a receiver end of a transmission path, optical phase modulated signals have to be converted to intensity modulated signals to permit signal detection since photodetectors are unable to discern phase differences in detected optical signals. Recently, however, there have been new architectures proposed for optical DQPSK signal demodulation (See, e.g., Doerr, C. R.; Gill, D. M.; Gnauck, A. H.; Buhl, L. L.; Winzer, P. J.; Cappuzzo, M. A.; Wong-Foy, A.; Chen, E. Y.; Gomez, L. T.; “Simultaneous reception of both quadratures of 40-Gb/s DQPSK using a simple monolithic demodulator”, OFC 2005, paper PDP12). With such approaches, a DQPSK receiver includes a pair of delay interferometers (DI) followed by two pairs of balanced detectors, as shown schematically in FIG. 2. Each Di has optical delay of one symbol bit period for achieving interference of two adjacent bits. For DQPSK signal demodulation, extra phase shifts of 45 degree or −45 degree are introduced between the long arm and the short arm of the DI for demodulation of I and Q phase components, respectively. Advantageously, the DI can be based on Mach-Zehnder or Michelson interferometers.

To more fully understand the operation principle of a Di for DQPSK signal demodulation, we assume a Mach-Zehnder delay interferometer (MZDI) structure and a noise-free input DQPSK signal. The transmission at the constructive and destructive ports of a MZDI can be expressed as:

$$\begin{matrix}{T}_{Cons} = \frac{1}{2} ( 1 + cos ( 2 π f τ + {Δφ}_{Fix} + {Δφ}_{B} ) ) & [ 1 ] \\ {T}_{Des} = \frac{1}{2} ( 1 - cos ( 2 π f τ + Δ {φ}_{Fix} + {Δφ}_{B} ) ) & [ 2 ]\end{matrix}$$

where f is the light frequency, τ is the optical delay, Δφ_{Fix} is the phase shift in the MZDI, and Δφ_{B} is the phase difference between neighboring bits. When MZDI is used for optical DQPSK signal demodulation, τ should be very close to one symbol bit period and f·τ should be an integer. For I and Q phase signal demodulations, respectively ΔΦ_{Fix} equals π/4 or −π/4. For optical DQPSK signals, ΔΦB can be 0, π/2, π and 3π/2.

Upon balanced detection, the output electrical signal becomes

$$\begin{matrix}{i}_{I} ( f ) = \frac{{RA}^{2}}{2} \cdot cos ( 2 π f τ + \frac{π}{4} + {Δφ}_{B} ) & [ 3 ] \\ {i}_{Q} ( f ) = \frac{{RA}^{2}}{2} \cdot cos ( 2 π f τ - \frac{π}{4} + Δ {φ}_{B} ) & [ 4 ]\end{matrix}$$

where A is amplitude of the lightwave carrier, R is the photodetector responsivity, and a factor of ½ is included to count for the splitting loss of the optical coupler. The detection of optical DQPSK signals is shown in Table 1.

As can be appreciated by those skilled in the art, with the above analysis, f·τ should be an integer for correct demodulation of DQPSK signals. This condition can be satisfied by fine tuning the optical delay based on the incoming signal wavelength. For optical DQPSK signal demodulation, the conventional wisdom states that the optical delay τ should be close to one symbol bit delay (OSBD) to achieve maximal overlap of neighboring bits for interference.

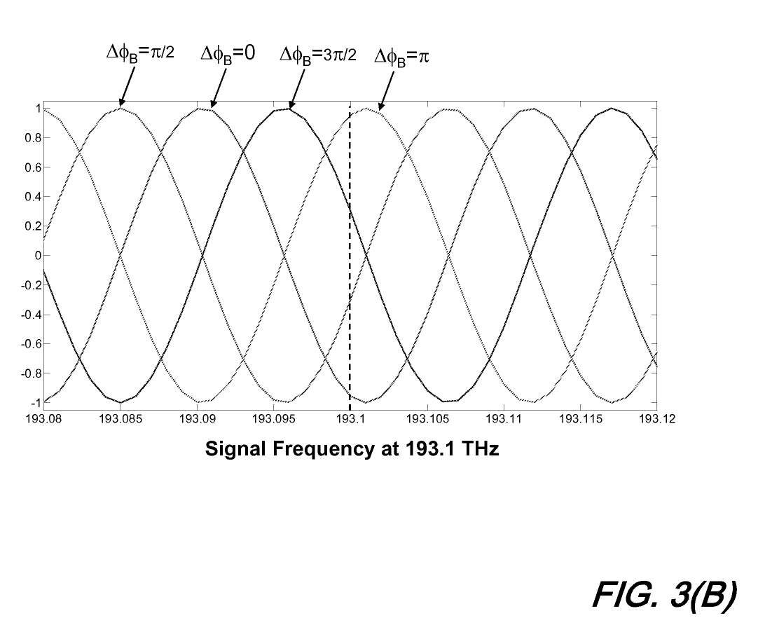

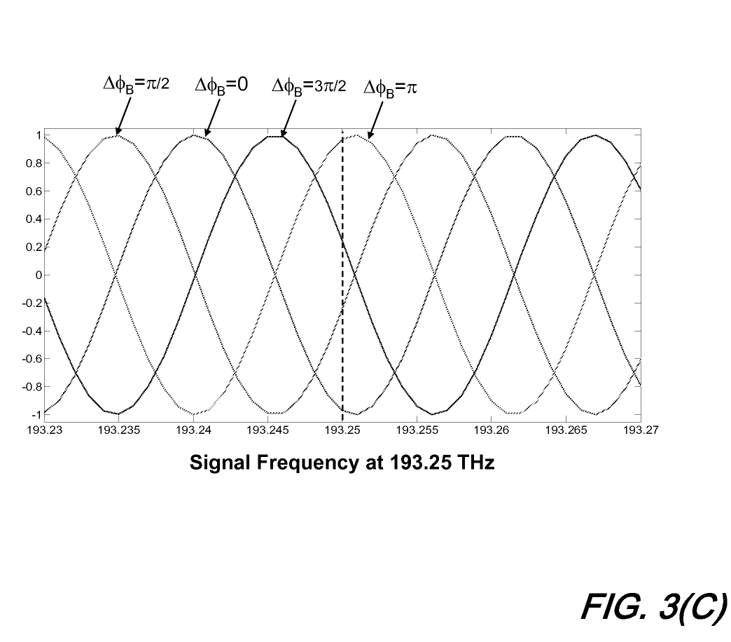

In general cases, the τ in a delay interferometer needs to be finely adjusted for signals at different wavelengths. As an example, when B=42.8 Gb/s (the bit rate for 40 Gb/s signal with enhanced forward error correction) and lightwave frequency f is 193.2 THz, τ should be 46.728778 ps for DQPSK symbol rate of 21.4 GSymbol/s. The transmission coefficients for the I phase signal after balanced detection under different Δφ_{B} are shown in FIG. 3., which further shows the transmission coefficients at central frequencies of 193.1 THz, and 193.25 THz under fixed optical delay of τ=46.728778 ps. Those skilled in the art will recognize that these frequencies are chosen based on the standard 50 GHz- and 100 GHz-spacing ITU frequency grids for DWDM communications.

Turning our attention now to that FIG. 3, there is shown transmission coefficients for I phase signal after balanced detection for a bit rate of 42.8 Gb/s, a symbol rate of 21.4 GSymbols/s and an optical delay of 46.728778 ps (optimized for lightwave frequency of 193.2 THz). In particular, FIG. 3(A) shows a signal frequency at 193.2 THz, FIG. 3(B) shows a signal frequency of 193.1 THz and FIG. 3(C) shows a signal frequency of 193.25 THz. Comparing FIG. 3(A), FIG. 3(B), and FIG. 3(C), we can observe that the MZDI optimized for 193.2 THz (3(A)) does not work for signals at lightwave frequencies of 193.1 THz or 193.25 THz. For 193.1 THz (3(B)) and 193.25 THz (3(C)), the corresponding optical delays which are close to OSBD should be 46.727084 ps and 46.727038 ps, respectively.

Colorless Optical DQPSK Demodulators

In DWDM communications, it is highly desirable to have fixed (passive) devices which can be applied to multiple channels. From equations (3) and (4), we can see that the transmission of an optical DQPSK demodulator is a simple cosine function with period of 1/τ, which is known as free spectral range (FSR). Considering that the standard ITU frequency grids have equal channel spacing of 50 GHz or 100 GHz, we note that an optical DQPSK demodulator can become “colorless” by supporting multiple DWDM channels if its FSR is set to agree with ITU grids and also close to signal symbol rate.

In practical implementations of optical DQPSK demodulators, the fixed phase shifts of π/4 or −π/4 for I- and Q-phase components can be achieved by precisely tuning the optical delay. For example, at 193.2 THz, the optical delay is 0.000647 ps for π/4 phase shift.

At this point we note that a fixed optical delay can satisfy only one wavelength to get an accurate π/4 phase shift. Fortunately, the ITU grids which are of interest for DWDM communications are within a relatively small wave band: 186.0 THz-191.0 THz for L band, 191.0 THz-196.0 THz for C band, and 196.0 THz-201.0 THz for S band. When the optical delay is adjusted to get π/4 phase shift for the central frequency of a wave band, we will get relatively small mismatch errors at the edge of the waveband. For example, in C band, the optical delay is 0.000646 ps for central frequency of 193.5 THz. The relative phase errors at 191.0 THz and 196.0 THz are −1.3% and 1.3%, respectively. Even at the low frequency edge of L band and high frequency edge of S band, the relative phase errors are about −3.9% and 3.9%, respectively.

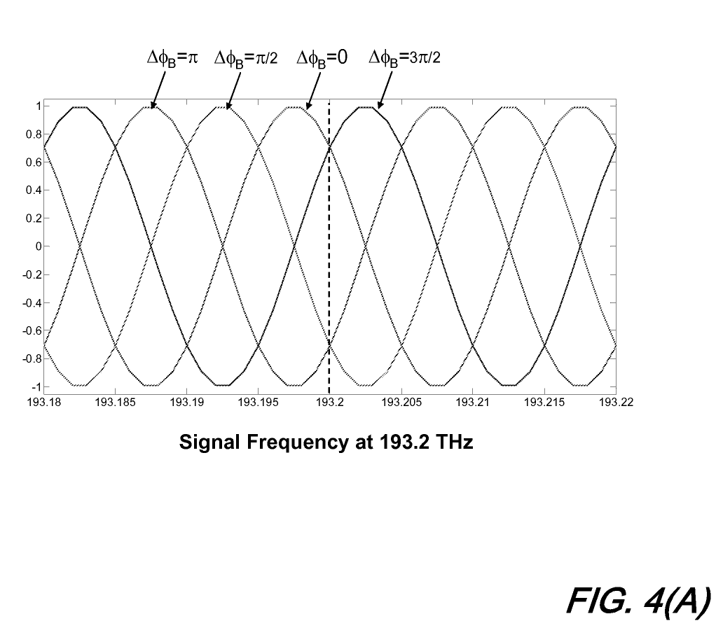

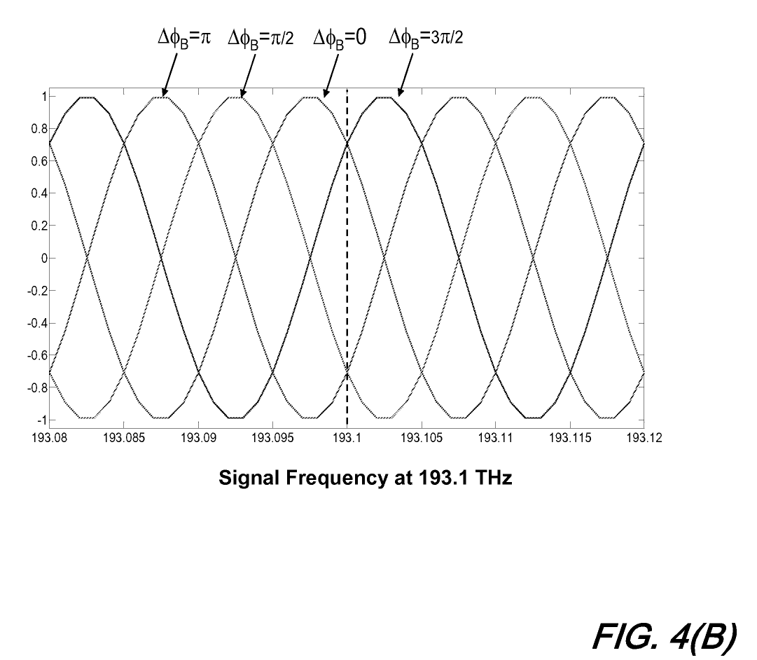

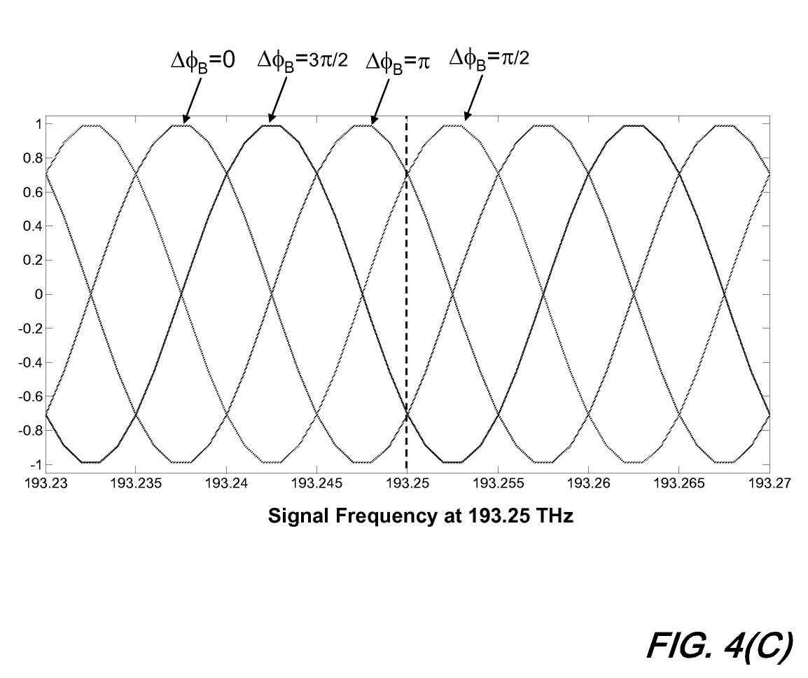

For 42.8 Gb/s optical DQPSK signals, we choose an optical delay of (50+0.000646)ps for I-phase signal demodulation. With reference to FIG. 4, there it shows the transmission coefficients after balanced detection for lightwave frequencies of 193.2 THz (FIG. 4(A)), 193.1 THz (FIG. 4(B)), and 193.25 THz (FIG. 4(C)).

With simultaneous reference now to FIG. 3 and FIG. 4, we can see that a fixed optical delay of 50.000646 ps in an optical DQPSK demodulator can be applied for DWDM signals at 100 GHz or 50 GHz channel spacing. Compared with FIG. 3(A) and FIG. 3(B), FIG. 3(C) shows demodulated signal with inverted data pattern, which can be corrected by using a data inverter or swapping the two connections between the optical demodulator and the balanced detector. When the FSR of an optical DQPSK demodulator is set to be around 25 GHz, the 40 Gb/s (or 42.8 Gb/s) optical DQPSK signals can be correctly demodulated with non-inverted data pattern on both 100 GHz and 50 GHz ITU grids. It is noted however, that one drawback for using 25 GHz FSR is a larger offset from the OSBD than 20 GHz FSR.

Simulation Methodology and Results

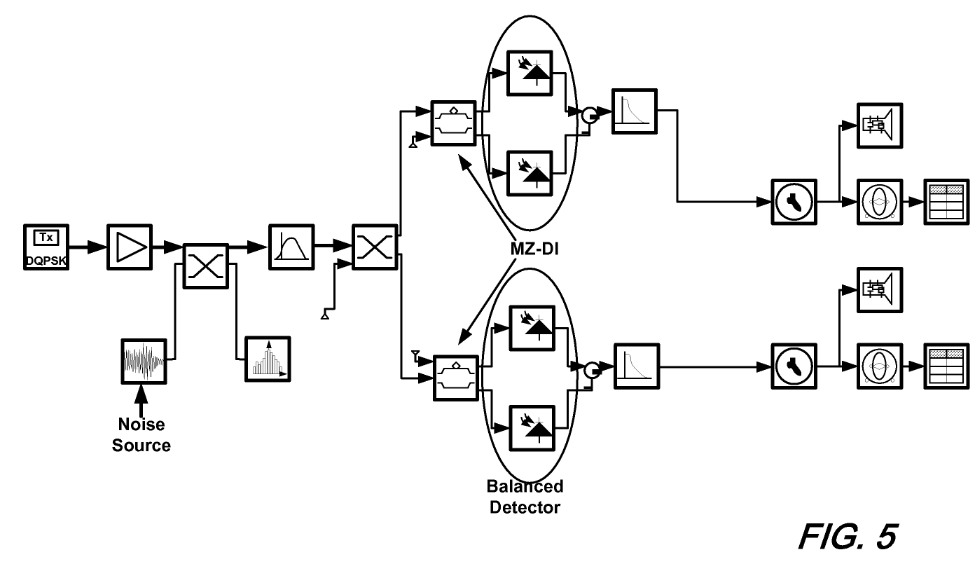

With this description in place, and as can now be appreciated by those skilled in the art, when the Free Spectral Range for a 40 Gb/s (or 42.8 Gb/s) DQPSK demodulator is set to 20 GHz or 25 GHz, fixed demodulators can be applied for multiple DWDM wavelengths on ITU grids, which advantageously eliminate the prior-art requirement for device tuning. To verify this, we performed a number of simulations to understand the system performance of optical DQPSK systems using colorless demodulators according to the present invention. The architectural layout employed for the simulation is shown schematically in FIG. 5.

As simulated, the system bit rate is set to 42.8 Gb/s. The generated DQPSK signal is a RZ type having a 33% duty cycle. To simulate the system performance under a variety of different optical signal-to-noise-ratios (OSNRs), an optical noise source is introduced into the channel under simulation. Additionally, the DQPSK signal is demodulated by a MZ delay interferometer followed by balanced detectors. Finally, the photodetector employed has a cutoff frequency of 20 GHz.

Simulations Using OSBD DQPSK Demodulator

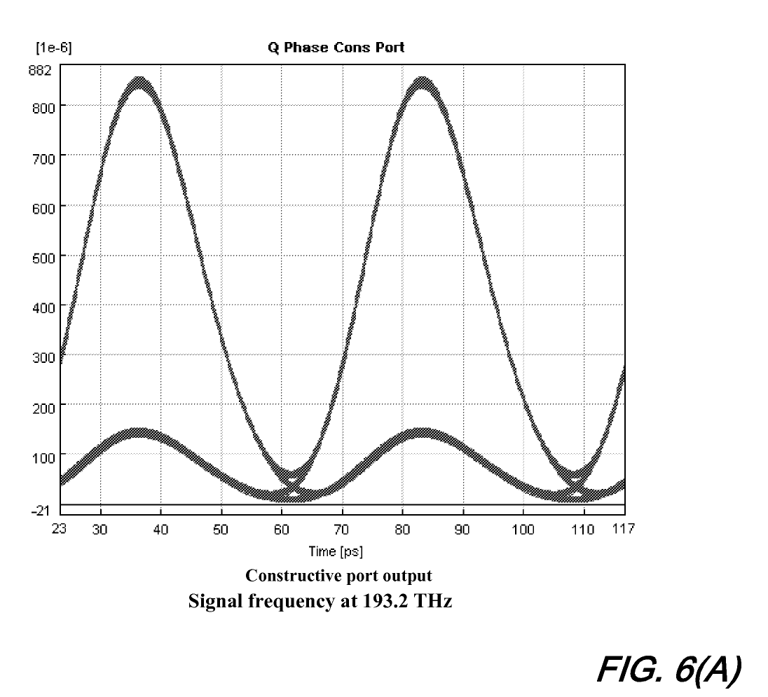

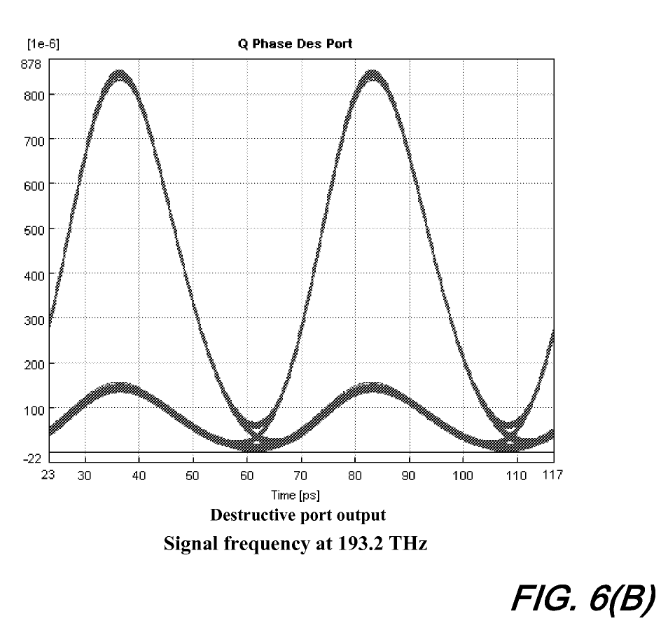

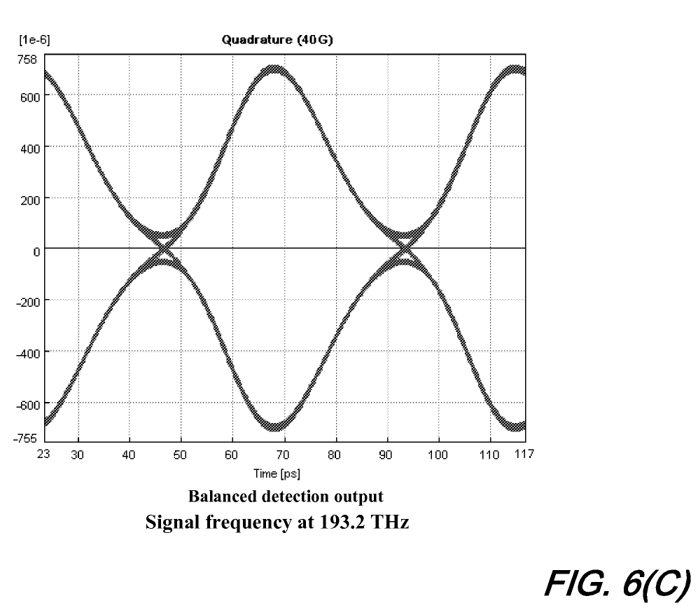

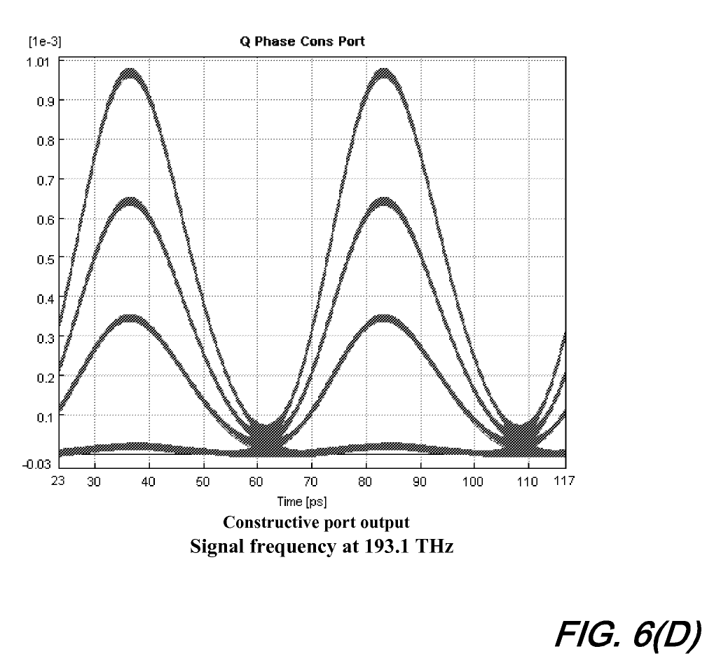

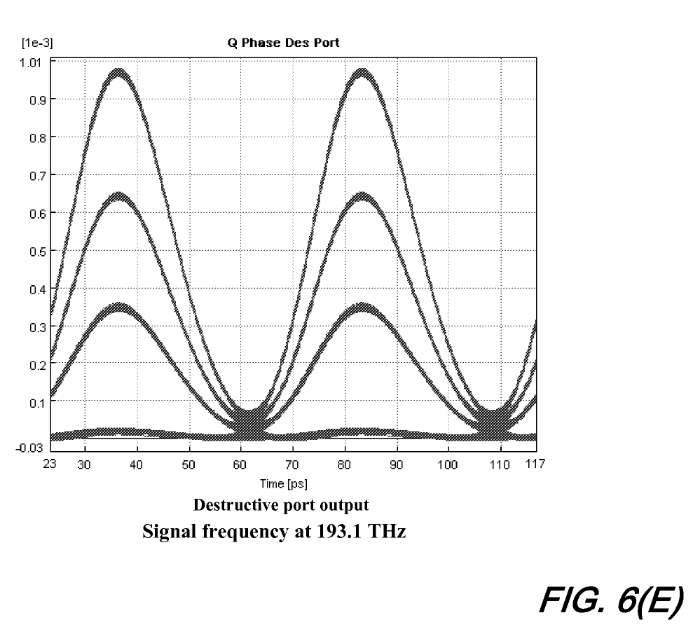

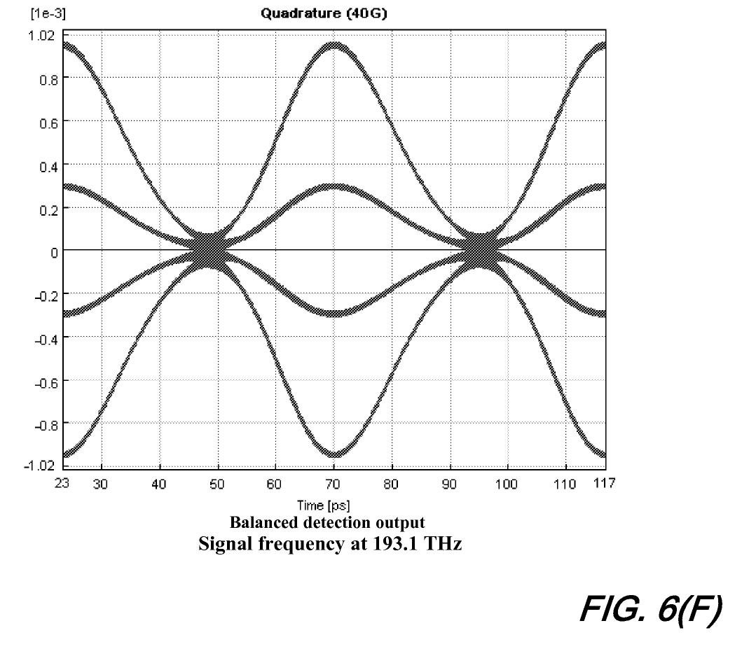

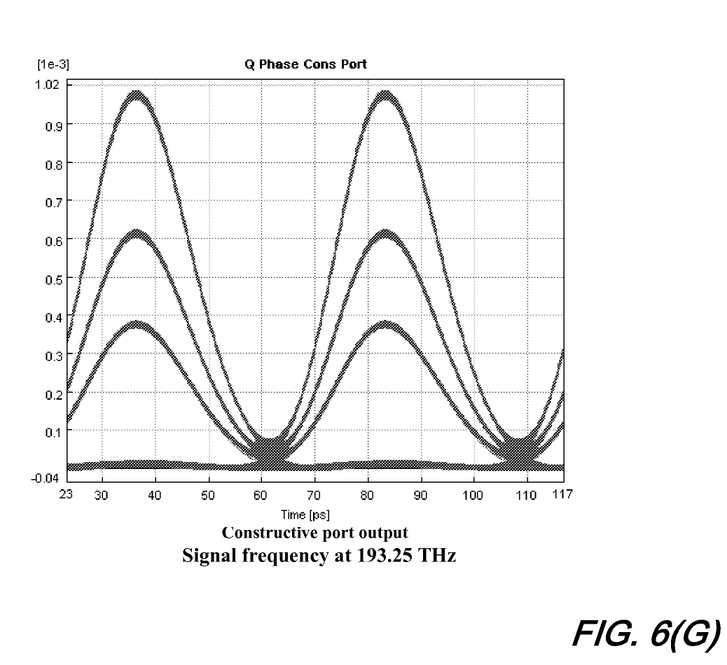

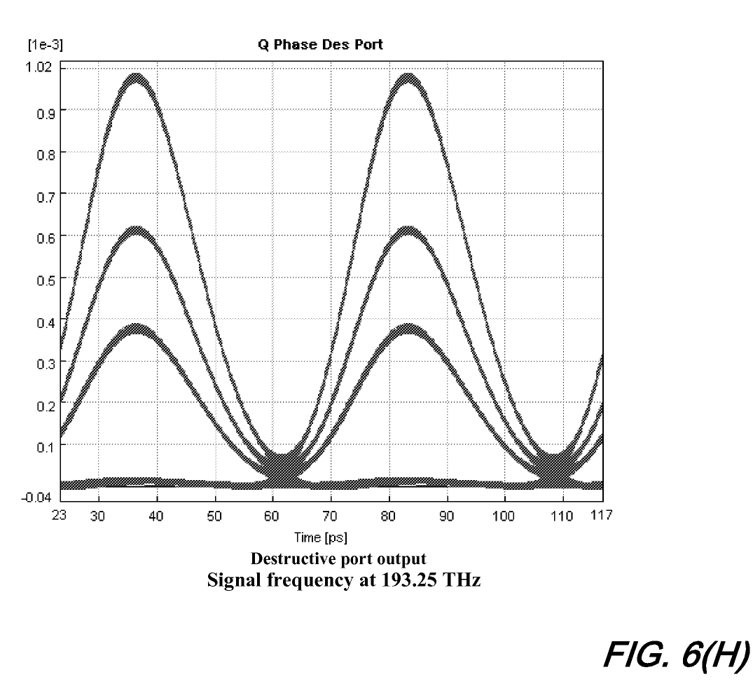

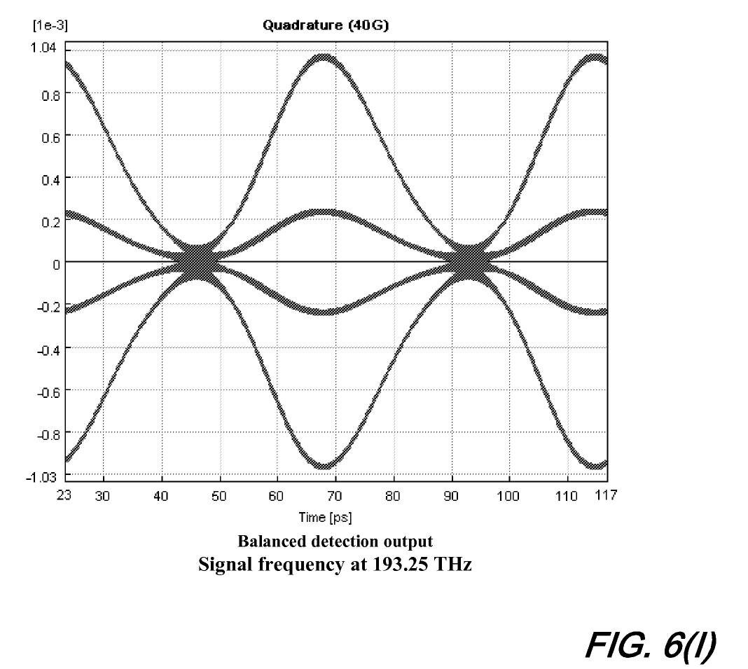

In initial simulations using an OSBD optical DQPSK demodulator, the optical delay for the I-phase and Q-phase components of the optical DQPSK signal at 193.2 THz is set to be (46.728778+0.000647) ps and (46.728778−0.000647) ps, respectively. Eye diagrams of the output Q-phase signals from the constructive port, the destructive port and after balanced detection are shown in FIG. 6(A). Unlike optical DPSK signal demodulation in which a single end output signal (from either constructive or destructive port of the demodulator) can have high extinction ratios, a single end output signal in optical DQPSK demodulation does not have high extinction ratios, and balanced detection is essential for high-quality output signals.

To demonstrate that precise tuning of optical delay is necessary for OSBD type demodulators, the input signal frequencies are changed to 193.1 THz and 193.25 THz. The demodulated signals are shown in FIG. 6(B) and FIG. 6(C), respectively. As can be observed from FIG. 6(B) and FIG. 6(C), the demodulated signals after balanced detection exhibit four power levels, corresponding to the quadrature phases of DQPSK signals. In principle, the eye diagrams shown in FIG. 6(B3) and FIG. (C3) can be used for data receiving with the aide of multi-level receivers. However, a high speed multi-level optical receiving scheme requires higher OSNR and is much more complicated. As a result, our attempts to date have been limited to two-level signal detection—such as that shown in FIG. 6(A3).

Simulations Using Colorless Optical DQPSK Demodulator

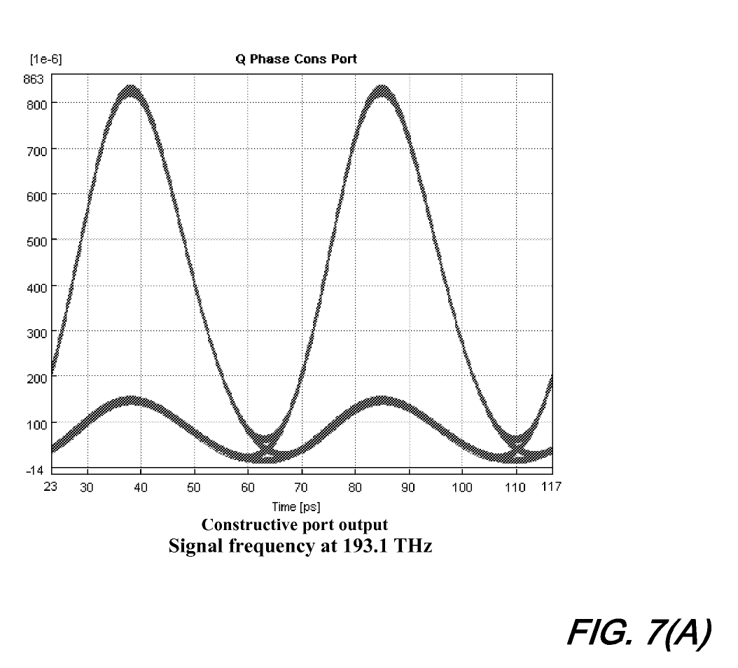

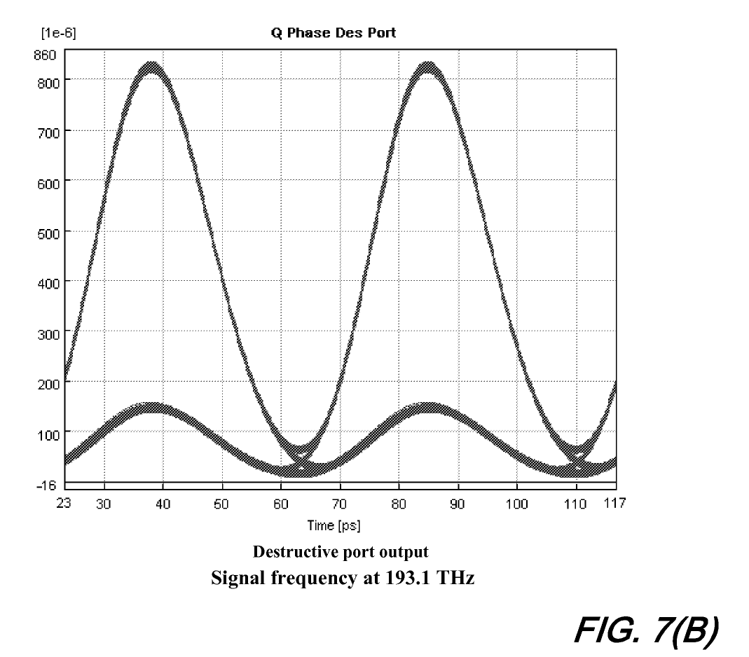

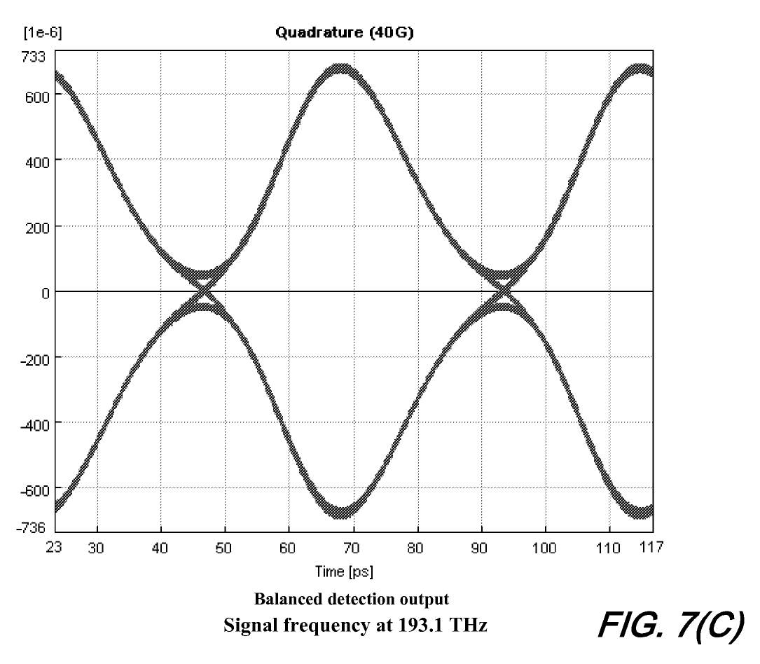

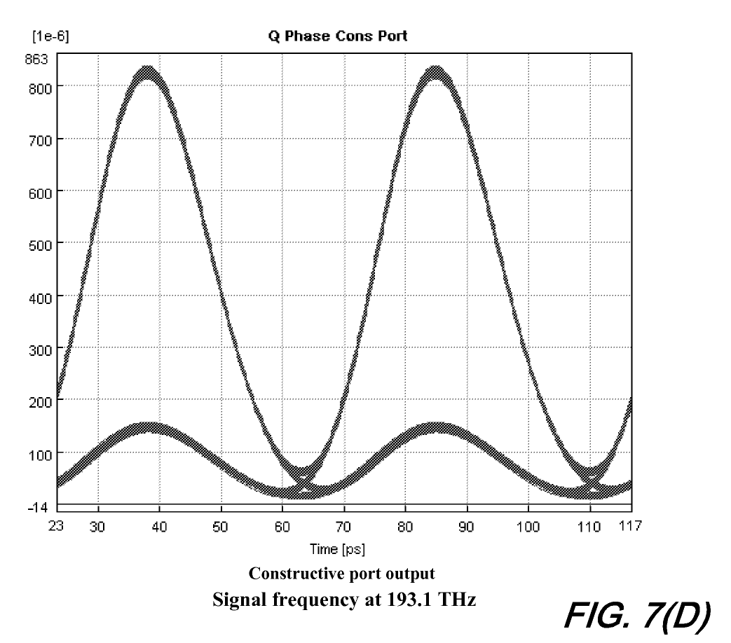

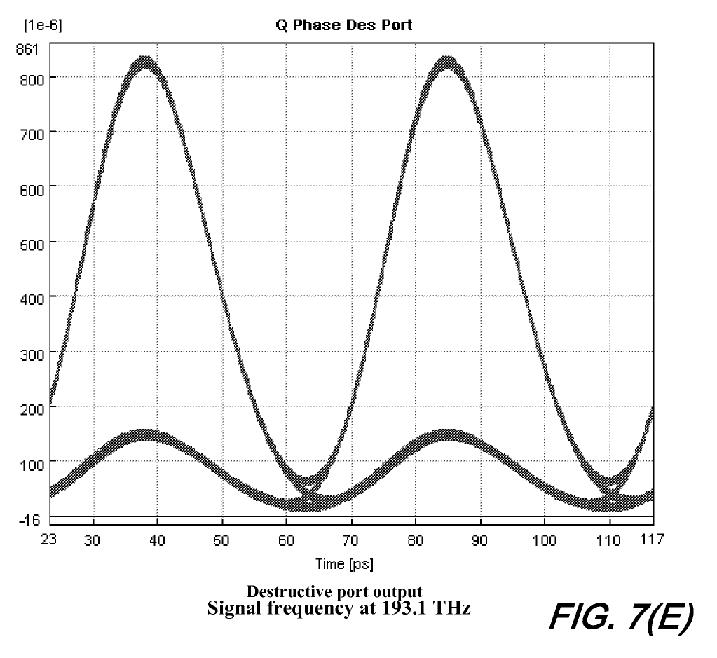

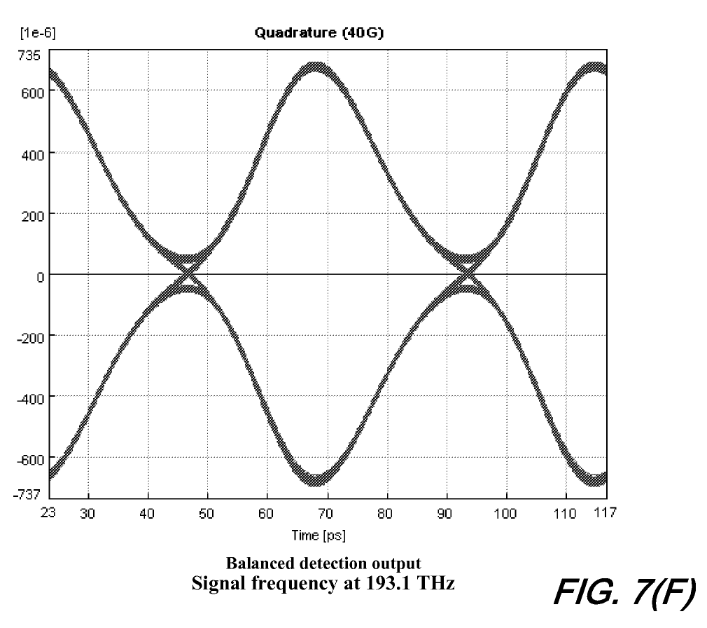

With the concept of colorless optical demodulation according to the present invention in place, the optical delay for the I-phase and Q-phase components of the optical DQPSK signal on ITU grids is set to be (50+0.000647) ps and (50-0.000647) ps, respectively. When the input optical DQPSK signal frequency is set at 193.1 THz and 193.25 THz, the eye diagrams of the Q phase component from the constructive port, the destructive port and after balanced detection are shown in FIG. 7(A), 7(B) and 7(C) respectively. Note that the data pattern for the received signal at 193.25 THz is inverted.

As compared with an optical DQPSK demodulator having a 50 ps delay (FSR of 20 GHz), a demodulator with a 40 ps delay (FSR of 25 GHz) can achieve non-inverted data receiving for DWDM DQPSK signals at either 100 GHz or 50 GHz ITU grids. However, for 40 Gb/s optical DQPSK signals (the actual bit rate is in the range of 40 Gb/s to 43 Gb/s), a 50 ps delay means smaller deviation from the OSBD than the 40 ps delay. A larger deviation will cause larger signal receiving penalties.

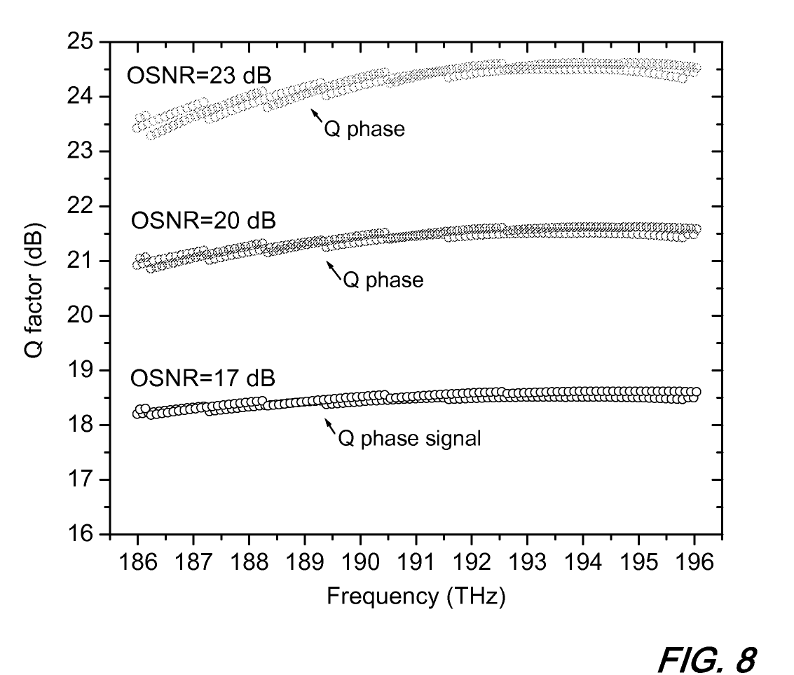

To demonstrate system performance of a colorless optical DQPSK demodulator according to the present invention over a wide range of DWDM ITU grids, we simulate the signal Q factors under different OSNRs. Turning our simultaneous attention now to FIG. 8 and FIG. 9, there is shown the results for an optical DQPSK receiver with a demodulator having an optical delay of about 50 ps and 40 ps, respectively. In both cases, the 45 degree phase offset required by DQPSK demodulator is optimized at the central wavelength of C-band (193.5 THz). The simulated channels cover both C-band and L-band. Compared with the Q factor of the signal at 193.5 THz which has the optimal working condition, the Q factor at the low frequency edge of L-band (186.0 THz) has degradations, which is mainly due to the small deviation from the condition of 45 degree offset. When the signal OSNR decreases, the signal Q factor degradation also decreases. In all the simulated cases, the Q factor penalty is less than ˜1 dB. When comparing an optical DQPSK demodulator using an optical delay of about 40 ps causes extra 1-2 dB Q factor penalty due to a larger variation from OSBD.

Influence of Laser Frequency Drift on Optical DQPSK Systems

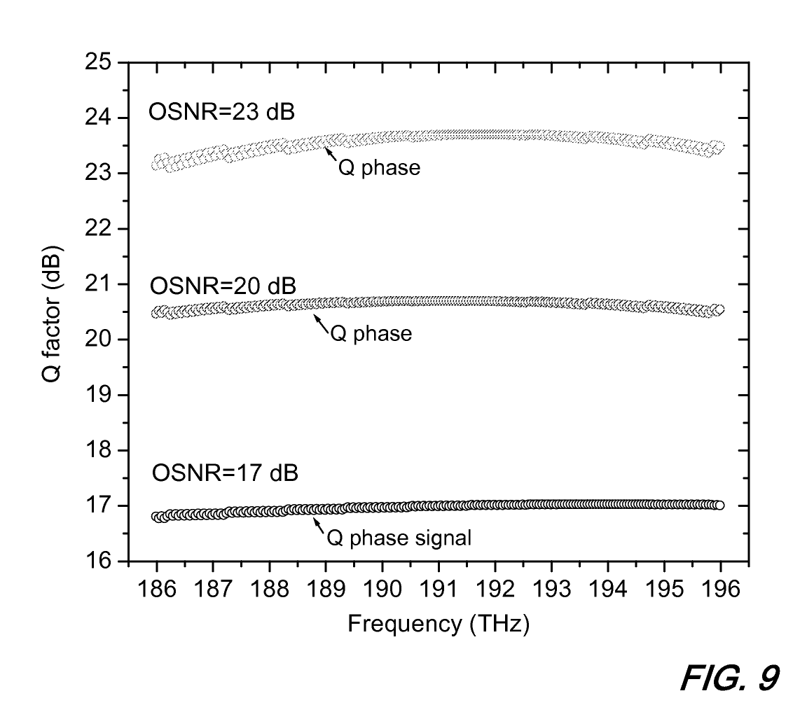

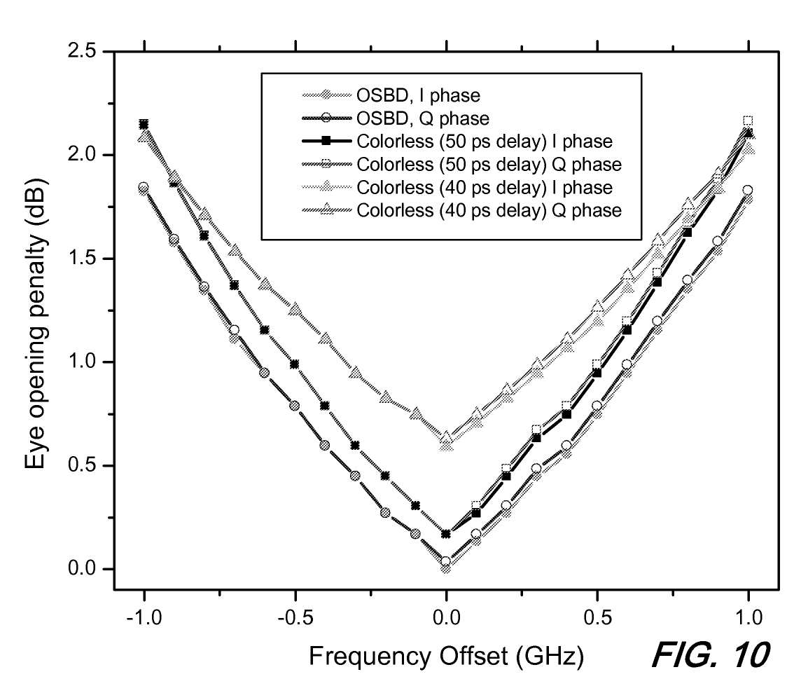

As can be readily appreciated by those skilled in the art, the central frequency(ies) of lasers employed in optical communication systems due—in part—to small fluctuations of injection current or environmental temperature. For our purposes, we simulated the eye opening penalty (EOP) of an optical DQPSK system using OSBD or colorless demodulators. With reference now to FIG. 10, there is shown a graph depicting this eye opening penalty vs. frequency offset at a number of different delay conditions. As depicted in that FIG. 10, the EOP is compared with the I-phase signal without frequency offset using OSBD. Within 1 dB EOP, the frequency drift tolerance is 630 MHz, 520 MHz, and 330 MHz for demodulators with OSBD, 50 ps delay, and 40 ps delay, respectively. The relatively small frequency drift tolerance under 1 dB EOP for 40-ps delay demodulator is due to the relatively large EOP penalty even without frequency drift. When increasing the EOP tolerance, the laser frequency drift tolerance for 40-ps delay demodulators can exceed that for 50-ps delay demodulators.

Colorless Demodulator for Applications in Reconfigurable WDM Networks

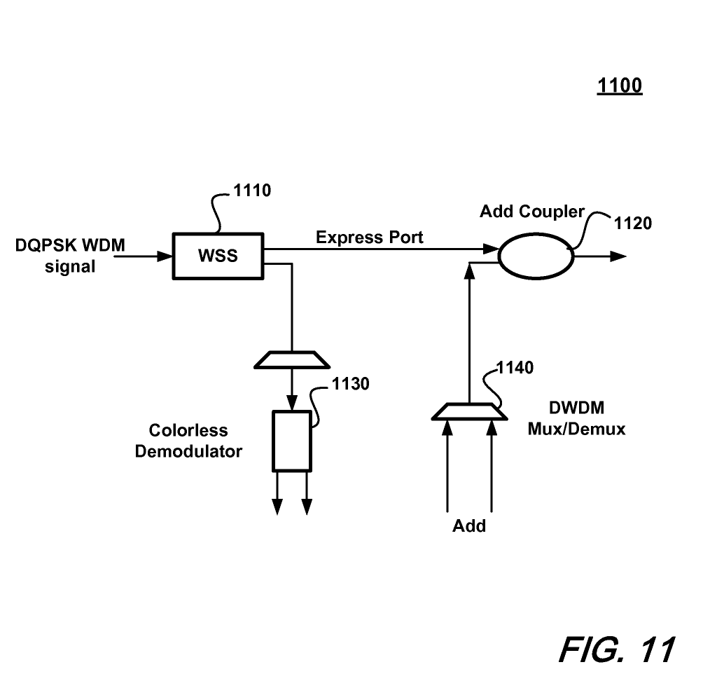

As is now readily apparent to those skilled in the art, the colorless DQPSK demodulator does not require active control. FIG. 11 is a schematic depicting a reconfigurable optical add drop multiplexer (ROADM) employing a colorless demodulator according to the present invention. More particularly, a DQPSK signal is received by a wavelength selective switch 1110 where a selected portion of the DQPSK signal is directed to the colorless demodulator 1130 for demodulation. Other, unselected portions of the WDM signal are conveyed by express port to an “ADD” coupler 1120 where other signals directed by DWDM Multiplexer/Demultiplexer 1140 are inserted into the signals.

Advantageously, by using fixed optical delays, colorless demodulators constructed according to the present invention are particularly well suited to be used as DQPSK demodulators for DWDM/DQPSK systems. Compared with prior art, conventional OSBD demodulators, the colorless demodulator of the present invention sacrifices the maximal overlap of neighboring bits, which causes only a small Q factor penalty. Advantageously however, the colorless aspect of the demodulator permits demodulation of multiple WDM channels without active tuning of the optical delay for each individual wavelength, which in turn significantly reduces the overall system cost and simplifies its operation.

Of course, it will be understood by those skilled in the art that the foregoing is merely illustrative of the principles of this invention, and that various modifications can be made by those skilled in the art without departing from the scope and spirit of the invention. Accordingly, the invention is to be limited only by the scope of the claims attached hereto.

What is claimed is:

1. A method of demodulating a multiwavelength optical DQPSK signal within an optical system having a plurality of optical DQPSK demodulators, said method comprising the steps of:
receiving the multiwavelength optical DQPSK signal;
separating the received multiwavelength DQPSK signal into a number of individual component wavelength signals;
directing each of the individual component wavelength signals into a respective one of the plurality of optical demodulators;
within each of the respective demodulators:
splitting the received individual component wavelength signal into two component signals wherein each of the two component signals exhibit substantially identical characteristics;
directing each of the two component signals into a respective Delay Interferometer (DI) each having two paths, such that two output signals are output from each of the respective DIs; and
directing the output signals from the two DIs into respective balanced detectors;
SAID METHOD CHARACTERIZED IN THAT:
each one of the plurality of demodulators are substantially the same regardless of the respective individual component wavelength signal received.

2. The method according to claim 1 wherein said colorless fixed delay produces an interference characteristic between signals traversing the two paths in each of the DIs.

3. The method according to claim 2 wherein said colorless fixed delay is characterized by a colorless delay parameter D which is defined by the relationship D±Nλ+⅛λ phase change where N is an integer and λ is the wavelength of light traversing the DI.

4. The method according to claim 3 wherein said fixed delay is set according to an ITU grid.

5. The method according to claim 4 wherein said optical DQPSK signal is a 40G signal and said fixed delay is one selected from the group consisting of: 40±0.000647 ps, and 50±0.000647 ps.

6. The method according to claim 4 wherein said optical DQPSK signal is an 80G signal and said fixed delay is one selected from the group consisting of 20±0.000647 ps, and 25±0.000647 ps.

7. The method according to claim 4 further comprising the steps of:
determining a difference between the two output signals for each one of the DIs thereby producing an intensity modulated signal for each one of the DIs.

8. The method according to claim 7 further comprising the steps of:
adjusting the amount of delay in the DI as a function of an extinction ratio.

9. A method of operating an optical communications network comprising a plurality of optically-connected transmitters and receivers wherein each of the receivers includes a plurality of colorless optical demodulators, the method comprising the steps of:
transmitting a multiwavelength optical DQPSK signal;
receiving the multiwavelength optical DQPSK signal; and
demodulating the received optical DQPSK signal with one or more of the colorless optical demodulators.

10. The method according to claim 9 further comprising the steps of:
separating the received multiwavelength optical DQPSK signal into a plurality of component wavelength signals; and
directing each one of the plurality or component wavelength signals into a respective one of the plurality of colorless optical demodulators.

11. The method according to claim 10 wherein each one of the individual colorless optical demodulators are substantially the same independent of the wavelength of the component wavelength signal directed into it:

12. The method according to claim 11 wherein said demodulation step comprises the steps of:
within each of the respective demodulators:
splitting the received individual component wavelength signal into two component signals wherein each of the two component signals exhibit substantially identical characteristics;
directing each of the two component signals into a respective Delay Interferometer (DI) each having two paths, such that two output signals are output from each of the respective DIs; and
directing the output signals from the two DIs into respective balanced detectors;
